(19) United States
(12) Patent Application Publication
(10) Pub. No.: US 2015/0036827 A1
(43) Pub. Date: Feb. 5, 2015

(54) Transaural Synthesis Method for Sound Spatialization

(71) Applicants: Franck Rosset, Bruxelles (BE); Jean-Luc Haurais, Paris (FR)

(72) Inventors: Franck Rosset, Bruxelles (BE); Jean-Luc Haurais, Paris (FR)

(21) Appl. No.: 14/377,935

(22) PCT Filed: Feb. 11, 2013
(86) PCT No.: PCT/FR2013/050278

§ 371 Date: Aug. 11, 2014

(30) Foreign Application Priority Data
Feb. 13, 2012 (FR) 125328

(51) Int. Cl. H04S 3/00

(52) U.S. Cl. CPC H04S 3/00
USPC 381/1

(57) ABSTRACT

A method for producing a digital spatialized stereo audio file from an original multichannel audio file, comprising a step of performing a processing on each of the channels for cross-talk cancelation; a step of merging the channels in order to produce a stereo signal; and a dynamic filtering and specific equalization step for increasing the sound dynamics.

### BACKGROUND

1. Field of the Invention

The present invention relates to the field of sound spatialization, also called spatialized rendering, of audio signals, more particularly integrating a room effect, especially in the field of transaural techniques.

The word “binaural” relates to the reproduction on a pair of headphones, or a pair of earpieces, or a pair of loudspeakers, of a sound signal, but still with spatialization effects. The invention is not however restricted to the above-mentioned technique and is notably applicable to techniques derived from the “binaural” techniques such as the “transaural” (registered tradename) reproduction techniques, i.e. on remote loudspeakers, for instance installed in a concert hall or in movie theatre with a multipoint sound system.

A specific application of the invention consists, for example, in enriching the audio contents broadcast by a pair of loudspeakers in order to immerse a listener in a spatialized sound scene, and more particularly including a room effect or an outdoor effect.

2. Prior Art

For the implementation of the “binaural” techniques on headphones or loudspeakers, a transfer function or filter is defined in the state of the art, for a sound signal between the position of a sound source in space and the two ears of a listener. The aforementioned acoustic transfer function of the head is denoted HRTF, for “Head Related Transfer Function”, in its frequency form and HRIR for “Head Related Impulse Response” in its temporal form. For one direction in space, two HRTFs are ultimately obtained: one for the right ear and one for the left ear.

More particularly, the binaural technique consists in applying such acoustic transfer functions for the head to monophonic audio signals, in order to obtain a stereophonic signal which, when listened to on a pair of headphones, provides the listener with the sensation that the sound sources originate from a particular direction in space. The signal for the right ear is obtained by filtering the monophonic signal by the HRTF of the right ear and the signal for the left ear is obtained by filtering the same monophonic signal by the HRTF of the left ear.

In the space rendering, when the fact that the listener perceives the sound sources at variable distances away from his/her head, which is a phenomenon known by the term “externalization”, is taken into account, in a manner that is independent from the direction or origin of the sound sources, it frequently happens, in a binaural 3D rendering, that the sources are perceived to be inside the head of the listener. The source thus perceived is referred to as “non-externalized”.

Various studies have shown that the addition of a room effect in the binaural 3D rendering methods allows the externalization of the sound sources to be considerably enhanced.

The patent application US 2007/011025A is known in the state of the art, which discloses a method for sound spatialization comprising a step of determining an acoustic matrix for a real set of sound sources at a real location and a step of calculating an acoustic matrix for the transmission of an acoustic signal of a set of apparent sound sources, at locations different from the real locations of the listener. The method further includes a step of resolution of a transfer function matrix to provide the listener with an audio signal creating an audio image of a sound originating from the apparent source.

The solutions of the prior art are set and do not enable to choose a 3D soundscape among several possible soundscapes. They are generally based on a transformation matrix calculated from a virtual head.

The solutions of the prior art generally do not enable one to have the sensation that the sound environment is externalized.

The physical rooms and the physical enclosures make it possible to calculate the filters which will be used to generate the multichannels.

### SUMMARY

In accordance with the present disclosure there is provided a method for producing a digital spatialized stereo audio file from an original multichannel audio file, characterized in that it comprises:
a step of performing a processing on each of the channels for cross-talk cancelation;
a step of merging the channels in order to produce a stereo signal;
a step of dynamic filtering and specific equalization for increasing the sound dynamics.

In an exemplary embodiment the method for producing a digital spatialized stereo audio file comprises the step of cross-talk cancelation consists in adding to the signal of each of the channels a signal corresponding to the out-of-phase and weighted signal of the other channels.

In an exemplary embodiment the method for producing a digital spatialized stereo audio file wherein the original signal is a native 5.n multichannel signal.

In an exemplary embodiment the method for producing a digital spatialized stereo audio file wherein the original signal is a native 5.n multichannel signal calculated from a stereo signal.

### BRIEF DESCRIPTION OF THE DRAWINGS

The present invention will be better understood by reading the following description, and referring to the appended drawings, wherein:

FIG. 1 shows a general block diagram of the installation intended for the step of producing the data base of pulse signals,

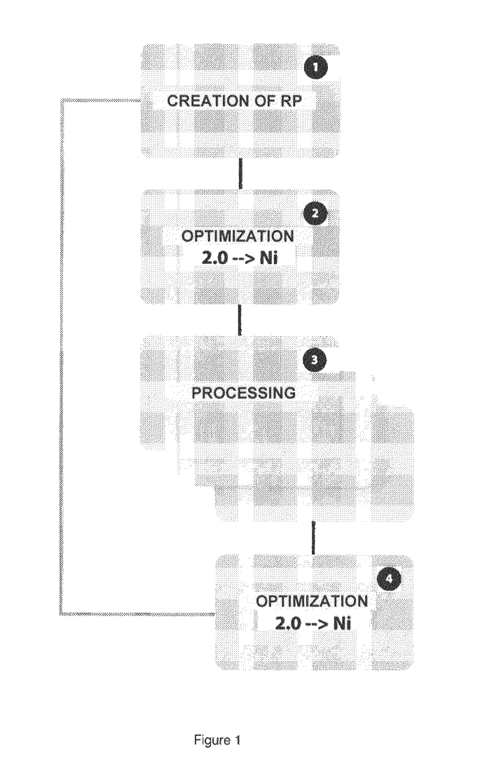

FIG. 2 shows a schematic view of the installation for the acquisition of the pulse signals,

FIG. 3 shows a block diagram of the listening installation.

### DETAILED DESCRIPTION

The method according to the invention comprises a first processing 1 consisting in producing a data base of pulse signals from the acquisition of acoustic signals in a plurality of physical spaces, by recording the signals produced by acoustic loudspeakers in response to a reference multifrequency signal.

Then, for each audio sequence to be spatialized, the method consists in applying a succession of processing operations:
when the signal to be spatialized is a stereo signal, the method comprises a preliminary step 2 of generating an N.i signal from the stereo signal,
a step 3 of transforming the signal of each one of the N.i channels from one of the pulse response files selected in the abovementioned data base,
a step 4 of recombining the signals of the thus transformed N.i channels to produce a spatialized stereo signal.

This stereo signal can then be broadcast by a couple of standard acoustic loudspeakers, in order to reproduce a spatialized soundscape corresponding to the space used for producing the pulse response signals or a combination of such spaces.

### Initial Step of Production of the Pulse Response Data Base

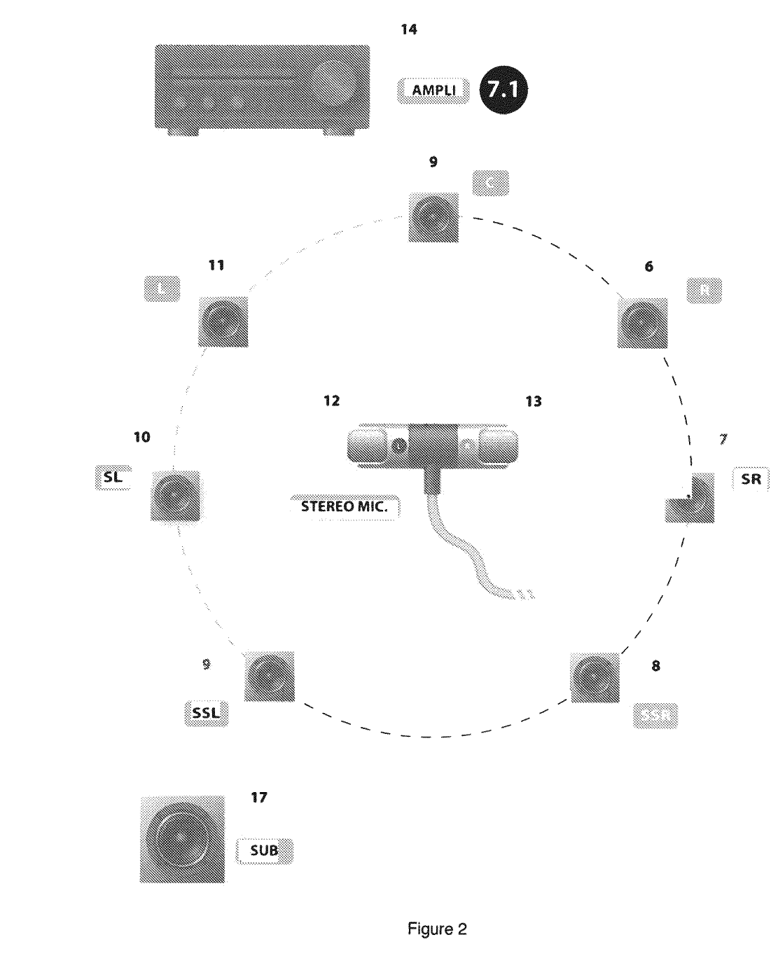

This step is repeated a plurality of times. It is illustrated in FIG. 2.

It consists, for each series of pulse responses, in positioning, in a physical space such as a concert hall, an open or a closed place, or given premises, a series of known acoustic loudspeakers 5 to 11; 17, associated with an amplifier 14, preferably of a known quality, as well as a couple of microphones 12, 13, the position of which relative to the series of loudspeakers 5 to 11; 17 is set for the series being acquired.

Then an original multifrequency signal is successively applied to each one of the loudspeakers 5 to 11 using the amplifier 14. Such original signal is for example a sequence having a duration ranging from 10 to 90 seconds, with a frequency variation within the sound spectrum. Such signal is for instance a linear variation between 20 Hz and 20 Khz, or still any signal covering the whole spectrum of the loudspeaker.

The sound signal produced by the active loudspeaker is picked up by the couple of microphones 12, 13 and produces a recorded stereo signal. From this signal, a 96 Khz sampling is knowingly executed as well as a deconvolution by fast Fourier transform between the original signal and the recorded signal, to produce a pulse response for the considered loudspeaker in the considered physical space.

This step is reproduced for each one of the loudspeakers 5 to 11 in the series, and then for various physical spaces wherein a series of loudspeakers, whether identical or different, are positioned together with an identical or different amplifier and identical microphones.

This first step leads to the production of a data base of stereo pulse responses.

### Step of Preparing a Spatialized Signal

This step makes it possible to produce a spatialized stereo audio signal from an N.i multichannel signal corresponding to a traditional digital recording.

Such step consists in selecting N+1 pulse responses from the data base created during the initial step.

The selection will consist in associating to each one of the N+1 signals one of the pulse responses of said data base, by taking care that the position of the acquisition in space of the pulse response corresponds to the position in space of the channel it is associated with.

For each “mono signal/stereo pulse response”, a convolution processing is applied in order to calculate a couple of stereo spatialized signals S_{sG} and S_{sD}.

Then N+1 couples of j spatialized signals S^{j}_{sG} and S^{j}_{sD}, with j ranging from 1 to N+1, are thus produced.

For example, if the initial recording was of the 5.1 type, 6 couples of spatialized signals will be produced.

Optionally, the channels are equalized to improve the dynamics of the j signals.

### Production of a Spatialized Stereo Signal

The final step consists in recombining the j signals to produce a couple of spatialized right and left signals.

Therefor, the j signals S^{j}_{sG} corresponding to the space positioned on the left are added to produce the left channel of the spatialized stereo signal. The same is done for the signals S^{j}_{sD} corresponding to the space positioned on the right to produce the right channel of the spatialized stereo signal.

Optionally, the channels are equalized to improve the dynamics of the j signals.

### Case of a Stereo Original Signal; Increase in the Number of Channels and Creation of Intermediary Channels

When the signal to be spatialized is not of the N.i type but simply a stereo signal, an intermediate step is executed, which consists in producing an N.i signal by phase extraction processing between the left track and the right track, to produce new different signals.

Such phase extraction consists in producing a signal corresponding to a reproduced central channel, through a processing consisting in adding the left channel signal and an out-of-phase right channel signal, for instance in anti-phase.

To create the other “reproduced” channels, the left and right tracks are phase-shifted, with different phase angles, and the couples of out-of-phase signals are added, with empirically determined weighting, in order to render a spatialized soundscape.

Besides, frequency filters are applied on the right and left signals, upon the creation of “reproduced” channels in order to increase the dynamics of the signal and keep a high-fidelity quality of the sound.

### Reproduction of the Signal

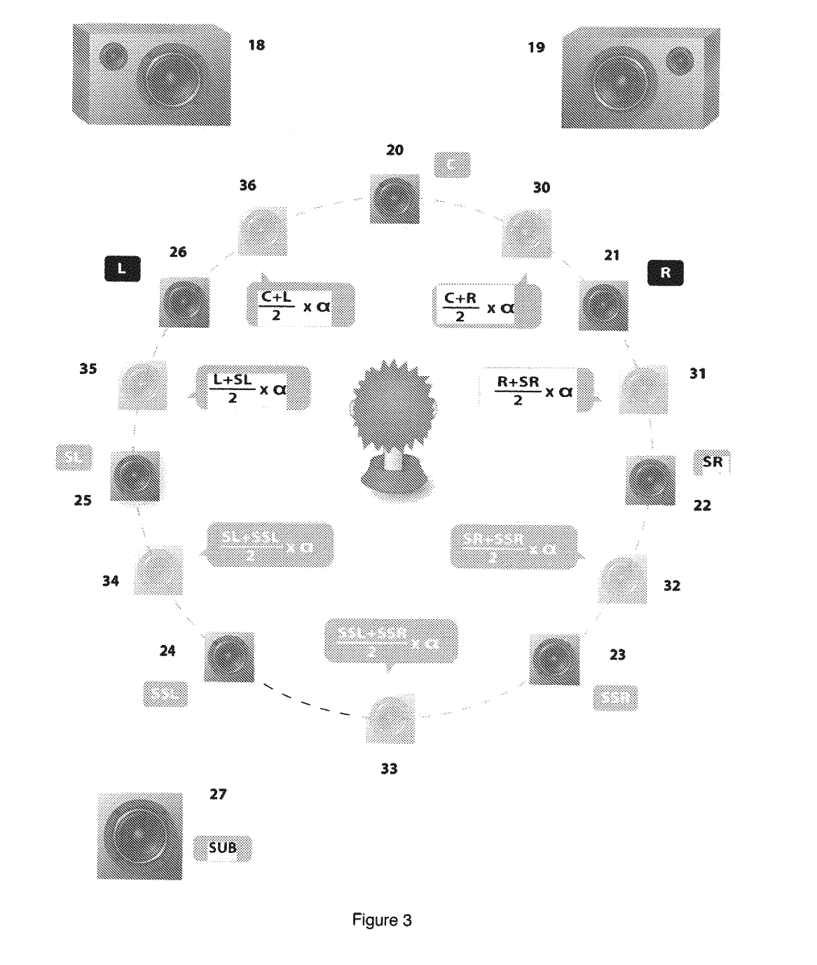

FIG. 3 shows a schematic view of the reproduction installation, from a pair of real loudspeakers 17, 18.

The loudspeakers 17, 18 receive a signal making it possible to simulate calculated loudspeakers 20 to 27 and 30 to 37.

The effective number of calculated loudspeakers 20 to 27 corresponds to the number of physical loudspeakers 5 to 11; 17 used for the production of the data base of pulse signals, or to the number of virtual loudspeakers reproduced according to the aforementioned method.

Besides, virtual loudspeakers 30 to 37 are created, thus producing a perception in the sound space of a combination of the neighbouring real loudspeakers, in order to fill the sound holes.

Such virtual loudspeakers are created by modifying the signal supplied to the neighbouring real loudspeakers.

Fifteen sound files are thus produced, 8 (7.1) corresponding to the processing from the pulse signals, and 7 ones being calculated by combining these fifteen files.

The signals are distributed according to their right, left or central component to produce a left signal 17 intended for the left loudspeaker, and a right signal intended for the right loudspeaker 18:
the “right” signal corresponds to the addition of the calculated “right” signals 21, 22, 23 and the virtual “right” signals 30, 31, 32, as well as the calculated 20, 27 and virtual 33 “central” signals with a weighting on the order of 50%.
the “left” signal corresponds to the addition of the calculated “left” signals 24, 25, 26 and the virtual “left” signals 34, 35, 36, as well as the calculated 20, 27 and virtual 33 “central” signals with a weighting of the order of 50%.

Such stereo signal is then applied to conventional audio equipment, connected to a pair of loudspeakers 18, 19 which will reproduce a spatialized soundscape corresponding to the soundscape of the installation which has been used for producing the data base of pulse signals, or a virtual soundscape corresponding to the combination of several original soundscapes, possibly enriched with virtual soundscapes.

1-4. (canceled)

5. A method of producing a digital spatialized stereo audio file from an original multichannel audio file, comprising:
processing on each of the channels for cross-talk cancelation;
merging the channels in order to produce a stereo signal; and
increasing sound dynamics through dynamic filtering and specific equalization.

6. The method of claim 5, wherein the step of cross-talk cancelation comprises adding to a signal of each of the channels a signal corresponding to the out-of-phase and weighted signal of other channels.

7. The method of claim 5, wherein the original signal is a native 5.n multichannel signal.

8. The method of claim 5, wherein the original signal is a native 5.n multichannel signal calculated from a stereo signal.
